(19) United States
(12) Patent Application Publication
(10) Pub. No.: US 2008/0031124 A1
(43) Pub. Date: Feb. 7, 2008

(54) Recording Medium, Recording Apparatus And Method, And Computer Program

(76) Inventor: Eiji Muramatsu, Saitama (JP)

Correspondence Address: YOUNG & THOMPSON, 745 SOUTH 23RD STREET, 2ND FLOOR, ARLINGTON, VA, 22202, US

(21) Appl. No.: 11/663,840

(22) PCT Filed: Sep. 27, 2005
(86) PCT No.: PCT/JP05/17700

§ 371 Date: May 25, 2007

(30) Foreign Application Priority Data
Sep. 28, 2004 (JP) 2004-282147

(51) Int. Cl. G11B 7/26

(52) U.S. Cl. 369/283

(57) ABSTRACT

A recording medium (100) is provided with: a substrate (120); and a plurality of coloring layers (111) which are laminated on the substrate and each of which presents a predetermined color, at least two adjacent coloring layers are mixed due to a change in temperature caused by irradiation of laser light in the plurality of coloring layers.

### TECHNICAL FIELD

The present invention relates to a recording medium, such as a DVD, a recording apparatus and method, such as a DVD recorder, and a computer program which makes a computer function as the recording apparatus.

### BACKGROUND ART

Recording media, such as CDs and DVDs, on which predetermined record information can be recorded by irradiating laser light thereon, are spread. Such a recording medium has an organic dye film, a phase change film, or the like, on its recording surface to record thereon the record information. Record pits (record marks) or the like formed by a change in conditions of the organic dye film and the phase change film allow the predetermined record information to be recorded. Specifically, in a case where the recording surface includes the organic dye film, the irradiation of the laser light causes the exothermic decomposition and thermal deformation of the organic dye film, whereby the record information is recorded. Namely, the record pits are formed by combining, as occasion demands, the sizes, locations to be formed, and the like of the organic dye films in two states of before and after the thermal deformation. Alternatively, in a case where the recording surface includes the phase change film, the irradiation of the laser light causes a mutual change in the phase state of the phase change film between a crystalline phase and an amorphous phase, whereby the record information is recorded. Namely, the record pits are formed by combining, as occasion demands, the sizes, locations to be formed, and the like of the phase change film in two states of the crystalline phase and the amorphous phase.

There has been developed a technology of drawing predetermined or desired characters (or letters), graphics, and the like, on the recording surface, by using such a principle of recording the record information and controlling the location to form each of the organic dye film before the thermal deformation and the organic dye film after the thermal deformation, or controlling the location to form each of the phase change film in the crystalline phase and the phase change film in the amorphous phase, as occasion demands.

On the other hand, as disclosed in a patent document 1, there has been developed a technology of drawing predetermined or desired characters (or letters), graphics, and the like, onto the recording medium, by using the recording medium having a plurality of coloring layers, each of which can develop a color (i.e. presents a predetermined color), aside from the recording layer in which the record information is recorded. According to the disclosure of the patent document 1, a color is developed in each of the coloring layers, separately, by irradiating each of the coloring layers with the laser light with a different power.

Patent document 1: Japanese Patent Application Laying Open NO. 2003-272240

### DISCLOSURE OF INVENTION

### Subject to be Solved by the Invention

However, with regard to the change in conditions of the organic dye film and the phase change film on the recording surface, generally, a contrast caused by the difference in conditions becomes small. Thus, there is such a technical problem that the characters, graphics, and the like, which can be easily visually recognized by a user, cannot be drawn. Moreover, because the change in conditions of the organic dye film and the phase change film on the recording surface is used, the characters, graphics, and the like can be drawn only in monotone. Thus, there is such a technical problem that it is hard or impossible to realize various types of drawings desired by the user.

On the other hand, according to the patent document 1, each of the plurality of coloring layers can develop a color, separately, so that various types of drawings are possible. However, in order to realize the configuration disclosed in the patent document 1, the materials of the coloring layers are possibly limited, which is also a technical problem. Namely, the configuration disclosed in the patent document 1 cannot be realized by using only the materials that can develop colors, and it is necessary to select the materials that can satisfy such a strict condition that a color is developed in each of the coloring layers, not by the laser light with the same power but by the laser light with a different laser power.

In order to solve the above-mentioned conventional problems, it is therefore an object of the present invention to provide a recording medium and a recording apparatus and method, which enable the recording of desired display targets with good visibility, as well as a computer program which makes a computer function as the recording apparatus.

### Means for Solving the Subject

(Recording Medium)

The above object of the present invention can be achieved by a recording medium provided with: a substrate; and a plurality of coloring layers which are laminated on the substrate and each of which presents a predetermined color, at least two adjacent coloring layers are mixed due to a change in temperature caused by irradiation of laser light in the plurality of coloring layers.

According to the recording medium of the present invention, it is possible to draw (or record) characters, numbers, graphics, and the like desired by a user or the like, onto the recording medium (particularly, on a label surface of the recording medium), by using the color developed (or presented) by each of the plurality of coloring layers.

Particularly in the present invention, in order to develop a plurality of colors, at least two adjacent coloring layers (or at least a partial area portion of the adjacent coloring layers) are mixed, to thereby develop a color different from the original colors which are developed by the coloring layers before mixed. For example, in case of the recording medium provided with: a first coloring layer; and a second coloring layer adjacent on the rear side (or farther side) of the first coloring layer as viewed from a user, two colors which are a color presented by the first coloring layer and a color presented by mixing the first and second coloring layers, can be used to draw the desired characters, numbers, graphics, and the like. Alternatively, in case of the recording medium provided with: a first coloring layer; a second coloring layer adjacent on the rear side of the first coloring layer as viewed from a user; and a third coloring layer adjacent on the rear side of the second coloring layer, three colors, which are a color presented by the first coloring layer, a color presented by mixing the first and second coloring layers, and a color presented by mixing the first, second, and third coloring layers, can be used to draw the desired characters, numbers, graphics, and the like. Furthermore, the same is true even if the number of the coloring layers is larger.

Moreover, the coloring layers are mixed due to the change in temperature caused by the irradiation of the laser light. At this time, by irradiating a particular area of the recording medium with the laser light, the desired characters, numbers, graphics, and the like can be drawn by using the color presented by mixing the coloring layers. For example, in case of the recording medium provided with a first coloring layer, a second coloring layer adjacent on the rear side of the first coloring layer, and a third coloring layer adjacent on the rear side of the second coloring layer, the first and second coloring layers are mixed if one temperature is given by the irradiation of the laser light with a first power, and the first, second, and third coloring layers are mixed if another temperature different from the one temperature is given by the irradiation of the laser light with a second power. As a result, the color of a partial area, which is irradiated with the laser light, is changed, and the characters, numbers, graphics, and the like can be drawn in the partial area as a whole (or as a combination with another area other than the partial area).

As described above, according to the present invention, since the desired characters, numbers, graphics, and the like can be drawn by using the plurality of colors, the aspects of the drawing (expression) are various. Namely, the characters, numbers, graphics, and the like can be drawn in various types of expression aspects by using two, three, or more colors. Alternatively, the characters, numbers, graphics, and the like can be drawn by using a contrast in dark coloring and light coloring of a single coloring layer, or dark coloring and light coloring of the mixed coloring layers, or the like. In particular, the present invention does not use the contrast of the organic dye film and the phase change film as in Background Art, but can use a contrast caused by the single coloring layer or caused by mixing the plurality of coloring layers. Thus, the characters, numbers, graphics, and the like can be drawn so as to increase the contrast. In summary, it is possible to draw the characters, numbers, graphics, and the like which are bright or well visible for a user.

In addition, since the plurality of coloring layers are mixed due to the change in temperature caused by the irradiation of the laser light, the desired targets (the characters, numbers, graphics, and the like) can be drawn by using an existing apparatus, such as, for example, a DVD recorder. Then, by changing the power of the laser light, as occasion demands, a different change in temperature can be easily given.

Consequently, according to the recording medium of the present invention, it is possible to record the desired display targets (e.g. the characters, numbers, graphics, and the like) with good visibility.

In another aspect of the recording medium of the present invention, a protective layer is provided between the plurality of coloring layers.

According to this aspect, due to the presence of the protective layer, it is possible to prevent a disadvantage of unexpected mixture of the plurality of coloring layers. Then, if the protective layer melts due to the change in temperature caused by the irradiation of the laser light, two coloring layers located to sandwich the protective layer can be mixed. Then, as described later, by adjusting the melting point of the protective layer, as occasion demands, at least two adjacent coloring layers can be preferably mixed, for example, as a user desires.

In an aspect of the recording medium provided with the protective layer, as described above, it may be further provided with a protective layer on a nearer side (i.e. closer side) than the coloring layer located on the nearest side as viewed from an irradiation side of the laser light.

By virtue of such construction, the coloring layer located on the nearest side (i.e. closest side) as viewed from the irradiation side of the laser light can be set not to be directly visually recognized by a user.

In an aspect of the recording medium provided with the protective layer, as described above, light absorptivity of the protective layer may be less than that of each of the plurality of coloring layers.

By virtue of such construction, the color presented by the protective layer is nearly white. Therefore, it is possible to relatively increase a contrast of the color presented by each of the plurality of coloring layers, or the color presented by mixing at least two coloring layers. In particular, if the protective layer, located on the nearer side than the coloring layer located on the nearest side (i.e. closest side) as viewed from the irradiation side of the laser light described above, has small light absorptivity, it is possible to further increase a contrast between the color of the protective layer and the color presented by each of the plurality of coloring layers, or the color presented by mixing at least two coloring layers. Thus, it is possible to draw the characters, numbers, graphics, and the like which are brighter and clearer (i.e. which can be easily visually recognized by a user).

In an aspect of the recording medium provided with the protective layer, as described above, the protective layer located on the nearest side as viewed from the irradiation side of the laser light may have the lowest melting point.

By virtue of such construction, the predetermined protective layer (or a partial area of the predetermined protective layer) melts due to the change in temperature caused by the irradiation of the laser light. As a result, at least two adjacent coloring layers (or one portion thereof) are mixed. In particular, by increasing the temperature given to the recording medium by the irradiation of the laser light, the protective layer or layers melt in order from the one located on the nearer side. Thus, by adjusting the power of the laser light, as occasion demands, the coloring layers to be mixed can be adjusted, as occasion demands.

In an aspect of the recording medium provided with the protective layer, as described above, a melting point of the protective layer may be higher than that of the coloring layer adjacent to the protective layer.

By virtue of such construction, if such a protective layer melts, the coloring layers adjacent to the protective layer also melt. Therefore, the adjacent two coloring layers can be mixed preferably and relatively easily, by melting the protective layer.

In an aspect of the recording medium further provided with the protective layer, as described above, a melting point of the protective layer may be higher than that of each of the plurality of coloring layers.

By virtue of such construction, at least two adjacent coloring layers can be mixed, preferably and relatively easily, by melting the protective layer.

In another aspect of the recording medium of the present invention, a thickness of each of the plurality of coloring layers is greater than that of the protective layer.

According to this aspect, it is relatively difficult for a user to visually recognize the protective layer, whereas it is relatively easy to visually recognize the coloring layers. Thus, it is possible to draw the characters, numbers, graphics, and the like which are brighter and clearer, by using the colors presented by the coloring layers.

In another aspect of the recording medium of the present invention, one of the coloring layers located on the nearest side as viewed from an irradiation side of the laser light has the lowest melting point.

According to this aspect, for example, even without the above-mentioned protective layer, the desired coloring layers can be preferably mixed due to the change in temperature caused by the irradiation of the laser light. In particular, the coloring layers are mixed in order from the one located on the nearer side. Therefore, even without the above-mentioned protective layer, the above-mentioned various benefits can be received.

In another aspect of the recording medium of the present invention, the plurality of coloring layers have respective different light absorption peaks.

According to this aspect, each of the plurality of coloring layers can present a different color, respectively. Therefore, it is possible to draw the characters, numbers, graphics, and the like, onto the recording medium by using more colors. Namely, the characters, numbers, graphics, and the like can be drawn, more colorfully.

In another aspect of the recording medium of the present invention, the plurality of coloring layers include a cyanine organic dye.

According to this aspect, it is possible to relatively easily realize the recording medium on which the plurality of coloring layers, which present various colors, are laminated.

In another aspect of the recording medium of the present invention, it is further provided with a recording layer in which predetermined record information can be recorded.

According to this aspect, it is possible to draw the desired display targets with good visibility, as described above, and it is also possible to record the predetermined record information into the recording layer.

(Recording Apparatus)

The above object of the present invention can be also achieved by a recording apparatus provided with: an irradiating device for irradiating the above-mentioned recording medium of the present invention (including its various aspects) with the laser light; a power controlling device for controlling a power of the laser light; and a position controlling device for controlling a position which is irradiated with the laser light.

According to the recording apparatus of the present invention, by virtue of the operation of the irradiating device, the laser light is irradiated onto the plurality of coloring layers (or at least its partial area). As a result, the temperature changes, and at least two adjacent coloring layers are mixed.

At this time, by virtue of the operation of the power controlling device, the power of the laser light to be irradiated is controlled (adjusted). The power of the laser light is controlled on the basis of the degree (rate/extent) of the change of the temperature to be given to the plurality of coloring layers. Namely, the laser light is irradiated from the irradiating device so as to have the power strong enough to give the change of the temperature which enables the two or more coloring layers to be mixed, which are located in the desired partial area. In addition, by virtue of the operation of the position controlling device, the position of the laser light to be irradiated is controlled (adjusted). The position of the laser light is controlled on the basis of the target to be drawn onto the recording medium (e.g. the characters, numbers, graphics, and the like). In summary, by virtue of the operation of each of the power controlling device and the position controlling device, the laser light with a desired power is irradiated in a desired position. As a result, it is possible to draw the desired targets onto the recording medium.

Consequently, according to the recording apparatus of the present invention, it is possible to relatively easily draw the desired targets onto the recording medium of the present invention.

Incidentally, in response to the various aspects of the recording medium of the present invention described above, the recording apparatus of the present invention can also adopt various aspects.

In one aspect of the recording apparatus of the present invention, the recording medium is further provided with a recording layer in which predetermined record information can be recorded, and the recording apparatus is further provided with a recording device for recording the record information.

According to this aspect, it is possible to draw the desired display targets with good visibility, as described above, and it is also possible to record the predetermined record information into the recording layer.

(Recording Method)

The above object of the present invention can be also achieved by a recording method provided with: an irradiating process of irradiating the above-mentioned recording medium of the present invention (including its various aspects) with the laser light; a power controlling process of controlling a power of the laser light; and a position controlling process of controlling a position which is irradiated with the laser light.

According to the recording method of the present invention, it is possible to receive the same various benefits as those of the above-mentioned recording apparatus of the present invention.

Incidentally, in response to the various aspects of the recording apparatus of the present invention described above, the recording method of the present invention can also adopt various aspects.

(Computer Program)

The above object of the present invention can be also achieved by a computer program for recording control to control a computer provided in the above-mentioned recording apparatus including its various aspects), to make the computer function as at least one of the irradiating device, the power controlling device, and the position controlling device.

According to the computer program of the present invention, the above-mentioned recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the above-mentioned recording apparatus of the present invention, the computer program of the present invention can adopt various aspects.

The above object of the present invention can be also achieved by a computer program product in a computer-readable medium for tangibly embodying a program of instructions executable by a computer provided in the above-mentioned information recording apparatus of the present invention (including its various aspects), to make the computer function as at least one of the irradiating device, the power controlling device, and the position controlling device.

According to the computer program product of the present invention, the above-mentioned information recording apparatus of the present invention can be embodied relatively readily, by loading the computer program product from a recording medium for storing the computer program product, such as a ROM (Read Only Memory), a CD-ROM (Compact Disc—Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-mentioned information recording apparatus of the present invention.

These effects and other advantages of the present invention will become more apparent from the following embodiments.

As explained above, according to the recording medium of the present invention, it is provided with the substrate and the plurality of coloring layers, and at least two of the plurality of coloring layers are mixed by giving a predetermined temperature. Therefore, it is possible to draw the desired display targets with good visibility.

### BRIEF DESCRIPTION OF DRAWINGS

FIG. 1 are a substantial plan view and a schematic cross sectional view showing the basic structure of an optical disc in an embodiment of the recording medium of the present invention.

FIG. 2 are cross sectional views schematically showing the structure of a label layer provided for the optical disc in the embodiment.

FIG. 3 are chemical formulas indicating one specific example of organic dyes used to form the coloring layers of the label layer provided for the optical disc in the embodiment.

FIG. 4 are a cross sectional view and a plan view particularly showing an aspect of the label layer of the optical disc in a case where a partial area of the optical disc is irradiated with laser light with a first laser power.

FIG. 5 are a cross sectional view and a plan view particularly showing an aspect of the label layer of the optical disc in a case where another partial area of the optical disc is irradiated with laser light with a second laser power.

FIG. 6 are a cross sectional view and a plan view particularly showing an aspect of the label layer of the optical disc in a case where another partial area of the optical disc is irradiated with laser light with a third laser power.

FIG. 7 are a cross sectional view and a plan view particularly showing an aspect of the label layer of the optical disc in a case where the partial area of the optical disc is irradiated with the laser light with the third laser power.

FIG. 8 is a block diagram showing an embodiment of the recording apparatus of the present invention.

### DESCRIPTION OF REFERENCE CODES

100 optical disc
110 label layer
111 coloring layer
112 protective layer
120a, 120b substrate layer
130 recording layer
300 recording apparatus
351 spindle motor
352 Optical pickup
353 signal recording/reproducing device
854 CPU
358 LD driver
359 servo circuit

### BEST MODE FOR CARRYING OUT THE INVENTION

Hereinafter, the best mode for carrying out the present invention will be discussed in order for each embodiment, with reference to the drawings.

Hereinafter, the embodiments of the present invention will be explained on the basis of the drawings.

(Recording Medium)

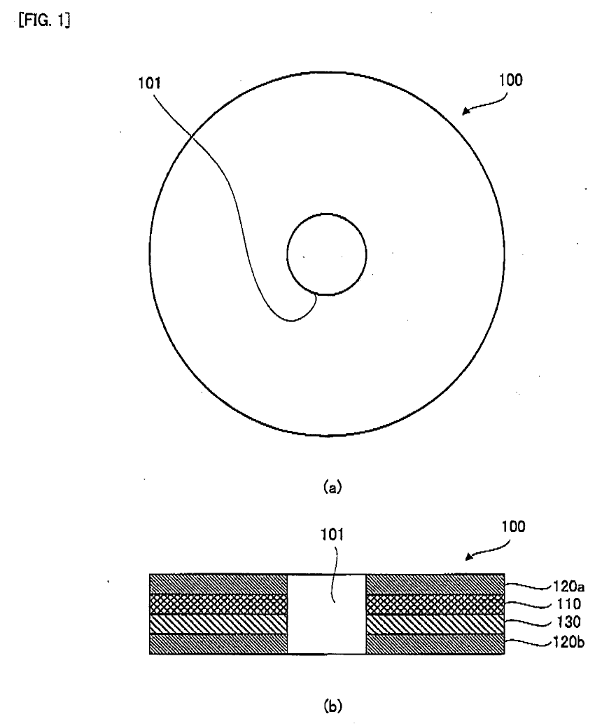

Firstly, with reference to FIG. 1 to FIG. 7, an embodiment of the recording medium of the present invention will be explained.

(1) Basic Structure

Firstly, with reference to FIG. 1, an explanation will be given for the basic structure of an optical disc in the embodiment of the recording medium the present invention. FIG. 1(a) is a substantial plan view showing the basic structure of the optical disc in the embodiment of the recording medium of the present invention, and FIG. 1(a) is a schematic cross sectional view of the optical disc.

As shown in FIG. 1(a), an optical disc 100 is disc-shaped, about 12 cm in diameter, having a center hole 101, as in a DVD. However, this shape and size are not limited to this example, and of course, various sizes and various shapes may be adopted.

As shown in FIG. 1(b), the optical disc 100 is provided with substrate layers 120a and 120b. A label layer 110 is formed on one side of the substrate layer 120a, and a recording layer 130 is formed on other side of the substrate layer 120b.

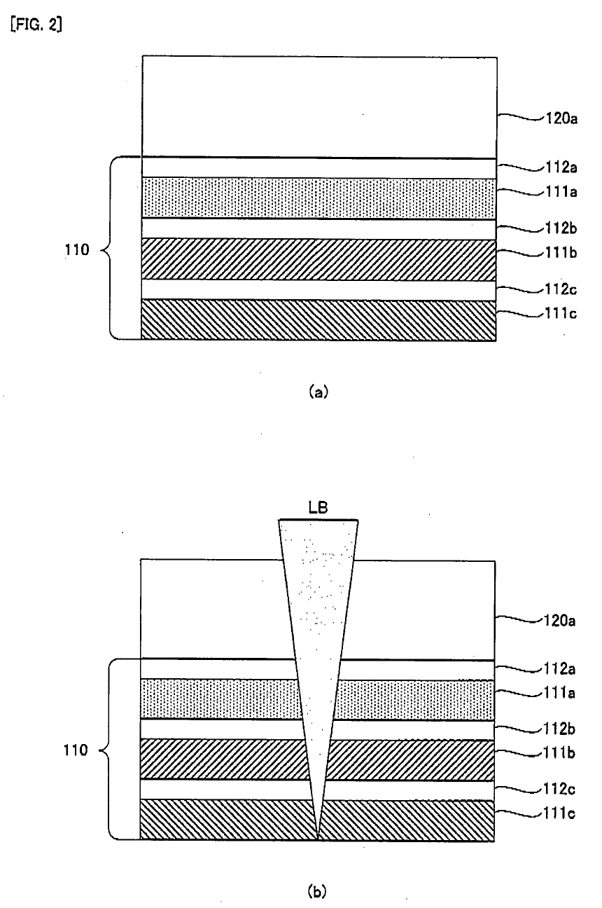

The label layer 110 is constructed to record therein information as for contents, such as, for example, the name, the writer, and the like of contents which is recorded onto the optical disc 100, by using characters (or letters), numbers, graphics, and the like. Alternatively, the label layer 110 is constructed to record, as occasion demands, for example, the characters (or letters), numbers, graphics, and the like, desired by a user of the optical disc 100. Particularly in the embodiment, the characters (or letters), numbers, graphics, and the like can be recorded (or drawn) into the label layer 110 by irradiating the label layer 110 with laser light LB while adjusting the laser power as occasion demands. The laser light LB at this time is irradiated from the upper side in FIG. 1(b). The specific structure of the label layer 110 will be described in detail later (refer to FIG. 2).

The substrate layers 120a and 120b include a member with some degree of hardness, such as, for example, silicon and plastic resins, and they are the support members of the entire optical disc 100. Then, each of the label layer 110 formed on one side of the substrate layer 120a and the recording layer 130 formed on one side of the substrate layer 120b are bonded by using various adhesives, such as, for example, epoxy resin.

Various record data, such as contents, are actually recorded in the recording layer 130. For example, if the optical disc 100 is a read-only recording medium on which the record data is recorded in advance (i.e. onto which the record data cannot be recorded by a user), such as, for example, a CD-ROM and a DVD-ROM, the record data is recorded by forming embossed pits and pre-record marks or the like on the recording surface of the recording layer 130. Alternatively, if the optical disc 100 is a recordable type recording medium on which the record data can be recorded only once or a plurality of times, such as, for example, a CD-R/RW and a DVD-R/RW, the recording surface of the recording layer 130 including the organic dye film and the phase change film is irradiated with the laser light LB with a predetermined power. The resulting record marks or the like allow the recording of the record data. The laser light LB at this time is irradiated from the lower side in FIG. 1(b).

Incidentally, the recording surface of the recording layer 130 may be divided into a plurality of areas, physically or logically. For example, it may be divided into: a user data area to record therein the record data corresponding to entity information including various contents, such as movies and music; and a lead-in area and a lead-out area to record therein the record data corresponding to control information or the like for controlling at least one of the recording and reproduction of the entity information. Moreover, it may be a multilayer type optical disc 100 with a plurality of recording layers 130 laminated.

Moreover, on the recording surface of the recording layer 130, not-illustrated groove tracks and land tracks, which serve as a guide when the record data is recorded, are alternately formed. Then, the irradiation of the laser light LB while tracing the groove tracks and land tracks, enables the formation of the record marks or the like on the groove tracks and/or land tracks, whereby the record data is recorded. Moreover, the groove tracks and land tracks may be oscillated or wobbled by performing BPM modulation thereon at a fixed spatial frequency or with using a predetermined cycle as a central frequency. Alternatively, for example, pre-pits may be formed on the land tracks, wherein the pre-pits generate a recording dock when the record data is recorded, or are used to obtain address positions on the recording surface.

Next, with reference to FIG. 2, the more detailed structure of the label layer 110 will be explained. FIG. 2 are cross sectional views schematically showing the structure of the label layer 110 provided for the optical disc 100 in the embodiment.

As shown in FIG. 2(a), the label layer 110 is provided with: a plurality of coloring layers 111 (i.e. coloring layers 111a, 111b, and 111c); and a plurality of protective layers 112 (i.e. protective layers 112a, 112b, and 112c). The coloring layers 111 and the protective layers 112 are formed to be alternately arranged. Incidentally, the film thickness of each of the coloring layers 111a, 111b, and 111c is, for example, about 200 nm, whereas the film thickness of each of the protective layers 112a, 112b, and 112c is, for example, about 50 nm. Of course, the specific numerical values of the film thickness are only one example, and obviously, numerical values different from the above-mentioned specific numerical values may be adopted.

The coloring layers 111 include, for example, organic pigments or dyes which present predetermined colors. In particular, each of the plurality of coloring layers 111a, 111b, and 111c presents a different color. Moreover, as shown in FIG. 2(b), the laser light LB with a predetermined laser power, irradiated onto the label layer 110 via the substrate layer 120a, melts at least one of the protective layers 112a, 112b, and 112c (more specifically, at least one portion thereof). As a result, at least two of the plurality of coloring layers 111a, 111b, and 111c (more specifically, at least one portion thereof are mixed and can also present a different color from the color presented singularly by each of the coloring layers 111a, 111b, and 111c.

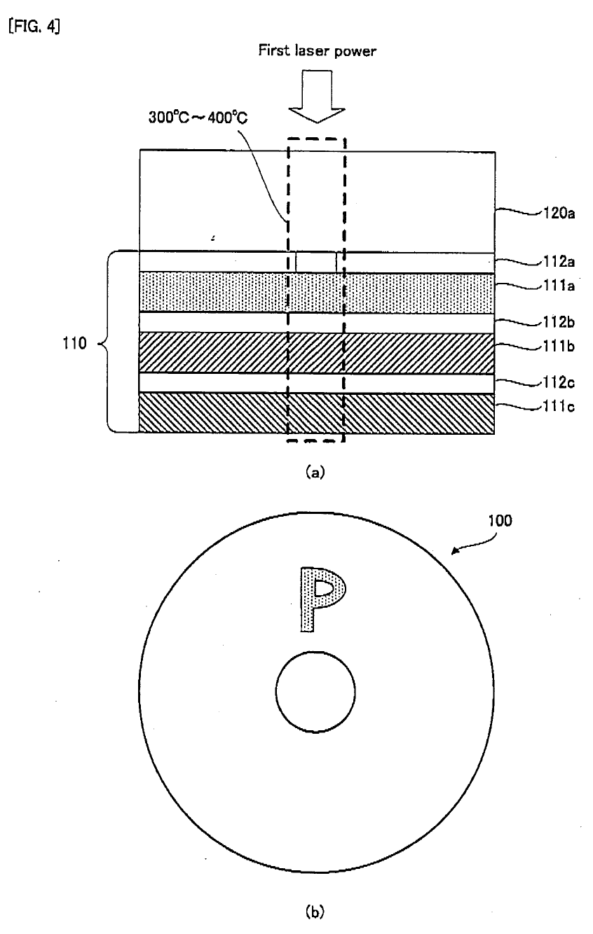

Then, by adjusting the area that presents the different color, i.e. by properly adjusting the area, which is visually recognized by a user as the coloring layer 111a itself, or as the mixture of at least two of the coloring layers 111a, 111b, and 111c, the predetermined or desired characters, numbers, graphics, and the like can be drawn into the label layer 110. The specific explanation on the drawings of the characters, numbers, graphics, and the like will be described in detail later (refer to FIG. 4 to FIG. 7).

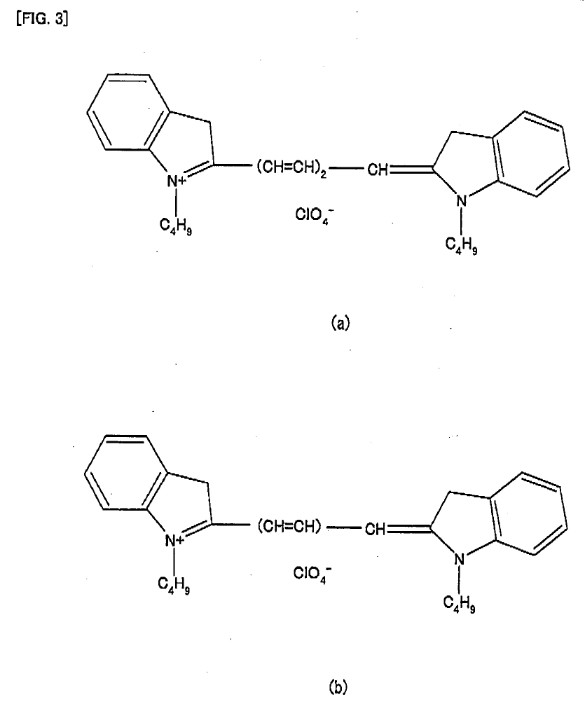

With reference to FIG. 3, an explanation will be given for one specific example of the organic dyes used for the coloring layers 111. FIG. 3 are chemical formulas indicating one specific example of the organic dyes used to form the coloring layers 111 of the label layer 110 provided for the optical disc 100 in the embodiment.

As shown in FIG. 3(a), for example, cyanine organic dyes can be used to form one of the coloring layers 111a, 111b, and 111c. For example, a cyanine organic dye identified by the chemical formula shown in FIG. 3(a) can absorb light with a wavelength of about 620 nm to 700 nm, to thereby present blue-green. The melting point of this cyanine organic dye is about 300 degree Celsius.

Moreover, a cyanine organic dye in which a structure portion expressed by (CH═CH)₂ out of the structure of the cyanine organic dye shown in FIG. 3(a) is changed to (CH═CH), presents a different color. Namely, as shown in FIG. 3(b), the cyanine organic dye in which the structure portion expressed by (CH=CH)₂ is changed to (CH=CH) can absorb light with a wavelength of about 500 nm to 580 nm, to thereby present red-blue. The melting point of this cyanine organic dye is about 300 degree Celsius, as in the cyanine organic dye with the structure before changed, shown in FIG. 3(a). By using such cyanine organic dyes, one of the coloring layers 111a, 111b, and 111c can be formed.

Moreover, various organic dyes other than the cyanine organic dyes specifically illustrated herein can be used to form one of the coloring layers 111a, 111b, and 111c. Then, by using the organic dyes which absorb light having respective different wavelengths to thereby form each of the coloring layers 111a, 111b, and 111c, more various types of colors can be developed in the label layer 110 as a whole. The relationship between the wavelength of the light to be absorbed and the developed color (presenting color) will be simply explained below. An organic dye which absorbs light having a wavelength of about 400 nm to 435 nm presents greenish yellow. An organic dye which absorbs light with a wavelength of about 485 nm to 480 nm presents yellow. An organic dye which absorbs light with a wavelength of about 480 nm to 490 nm presents orange. An organic dye which absorbs light with a wavelength of about 490 nm to 500 nm presents red. An organic dye which absorbs light with a wavelength of about 500 nm to 560 nm presents red-purple. An organic dye which absorbs light with a wavelength of about 560 nm to 580n=presents purple. An organic dye which absorbs light with a wavelength of about 580 nm to 695 nm presents blue. An organic dye which absorbs light with a wavelength of about 595 nm to 610 nm presents greenish blue. An organic dye which absorbs light with a wavelength of about 610 nm to 750 nm presents bluish green. An organic dye which absorbs light with a wavelength of about 750 nm to 800 nm presents green.

In FIG. 2(a) again, the protective layers 112 include, for example, white-colored (or blue-white colored or silver-white-colored) metal or alloy whose light-absorption spectrum has broad and small peaks. The protective layers 112 prevent the coloring layers 111a, 111b, and 111c from being unexpectedly mixed. On the other hand, if at least one of the protective layers 112a, 112b, and 112c melts, at least two of the coloring layers 111a, 111b, and 111c are mixed. For example, if the protective layer 112b melts, the coloring layers 111a and 111b are mixed. If the protective layer 112c melts, the coloring layers 111b and 111c are mixed. Moreover, each of the protective layers 112b and 112c melt, the coloring layers 111a, 111b, and 111c are mixed. Incidentally, if the protective layer 112a melts, at least two of the coloring layers 111a, 111b, and 111c are not mixed, but the coloring layer 111a is visually recognized by a user.

Particularly in the embodiment, the melting point of the protective layer 112a is lower than that of each of the protective layers 112b and 112c. In addition, the melting point of the protective layer 112b is lower than that of the protective layer 112c. Namely, the protective layer 112 located on a nearer side (or closer side) as viewed from the irradiation side of the laser light LB, have lower melting points.

Moreover, the melting point of each of the coloring layers 111a and 111b is lower than that of the protective layer 112b located between the coloring layers 111a and 111b. Moreover, the melting point of each of the coloring layers 111b and 111c is lower than that of the protective layer 112c located between the coloring layers 111b and 111c. However, the relationship among the melting points of the coloring layers 111a, 111b and 111c may be arbitrary if the above-mentioned relationship is satisfied.

By forming the coloring layers 111 and the protective layers 112 to satisfy such a relationship of the melting point and irradiating the laser light LB with a predetermined laser power, as described later, at least two of the coloring layers 111 are preferably mixed. Incidentally, since the metal or alloy with relatively high melting points is used as the protective layers 112, most part of the organic dyes used for the coloring layers 111 have lower melting points than those of the protective layers 112. Therefore, it can be said that the range of a selection of the organic dyes does not become narrower, even if the organic dyes used for the coloring layers 111 are selected so as to satisfy such a relationship of the melting point.

The metal or alloy used for the protective layers 112 will be specifically explained. Alloy, such as, for example, SnSb₅, is used for the protective layer 112a. For example, SnSb₅ presents a grayish metallic color and its melting point is about 232 to 240 degree Celsius. Moreover, metal, such as, for example, zinc (Zn), is used for the protective layer 112b. For example, zinc presents a blue-white metallic color and its melting point is about 419.58 degree Celsius. Moreover, metal, such as, for example, antimony (Sb), is used for the protective layer 112c. For example, antimony presents a silver-white metallic color and its melting point is about 630.7 degree Celsius. Incidentally, various metal and alloy other than the metal or alloy specifically illustrated herein can be used to form one of the protective layers 112a, 112b, and 112c.

Incidentally, each of the coloring layers 111a, 111b, and 111c may be solid or liquid because they are separated by the protective layers 112b and 112c. The point is that any state can be adopted as long as at least two of the coloring layers 111a, 111b, and 111c are mixed depending on the characters, numbers, graphics, and the like which a user desires to draw.

(2) Specific Use Aspects

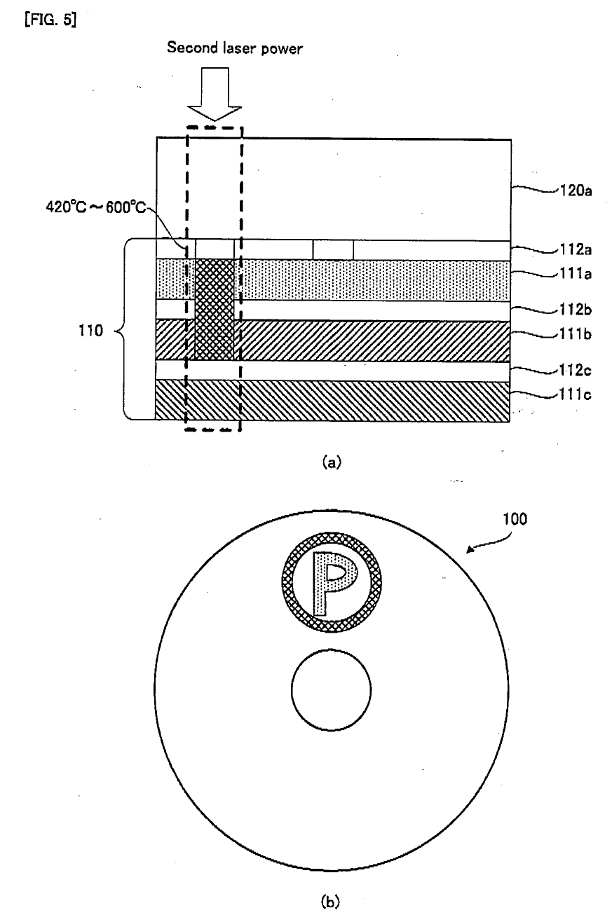

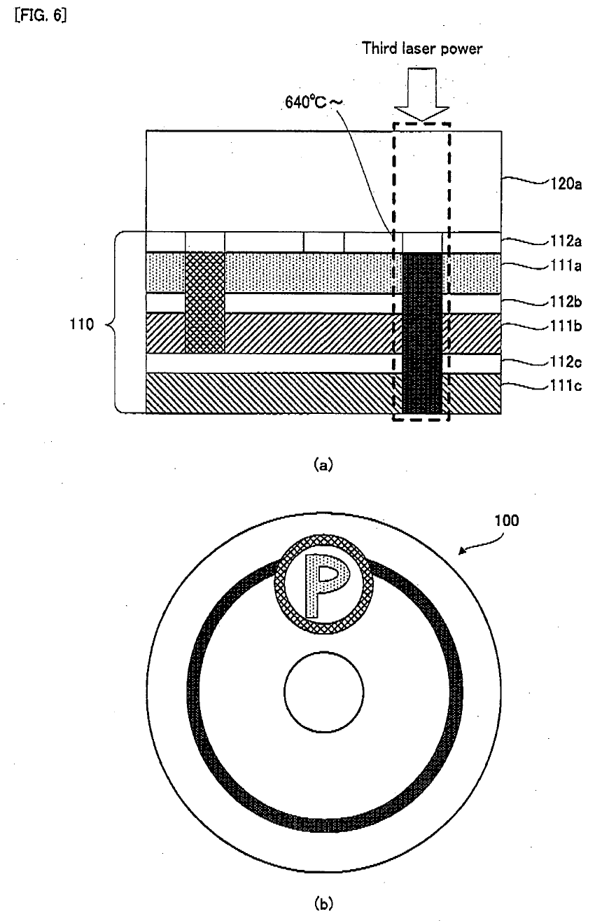

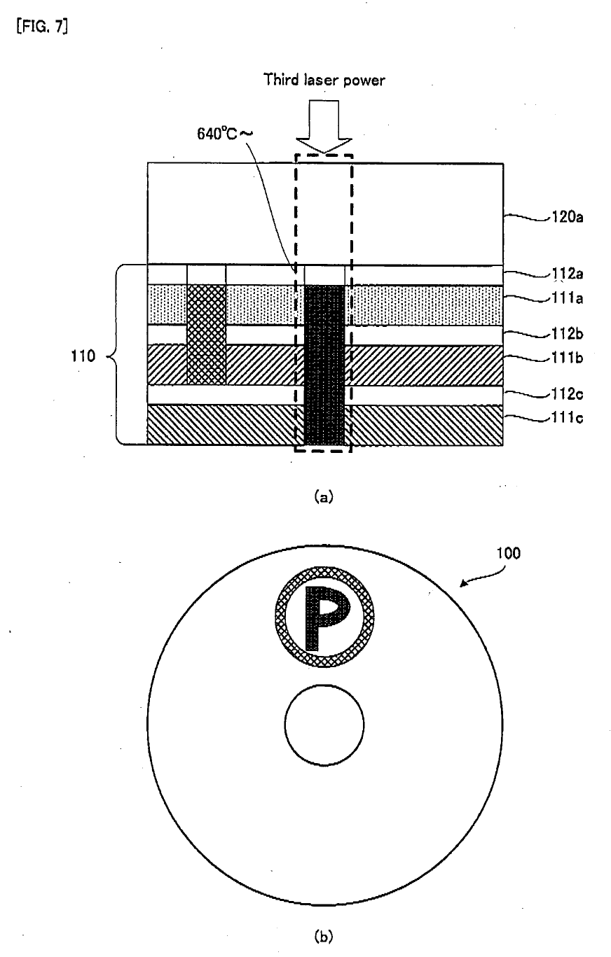

Next, with reference to FIG. 4 to FIG. 7, the specific use aspects of the optical disc 100 in the embodiment will be explained. FIG. 4 are a cross sectional view and a plan view particularly showing an aspect of the label layer 110 of the optical disc 100 in a case where a partial area of the optical disc 100 is irradiated with laser light with a first laser power. FIG. 5 are a cross sectional view and a plan view particularly showing an aspect of the label layer 110 of the optical disc 100 in a case where another partial area of the optical disc 100 is irradiated with laser light with a second laser power. FIG. 6 are a cross sectional view and a plan view particularly showing an aspect of the label layer 110 of the optical disc 100 in a case where another partial area of the optical disc 100 is irradiated with laser light with a third laser power. FIG. 7 are a cross sectional view and a plan view particularly showing an aspect of the label layer 110 of the optical disc 110 in a case where the partial area of the optical disc 110 is irradiated with the laser light with the third laser power.

Incidentally, here, the explanation will be given by using the optical disc which uses the organic dyes, metal or alloy or the like, which are specifically illustrated in the above-mentioned FIG. 2 and FIG. 3, as the coloring layers 111 and the protective layers 112. Namely, the explanation will be given by using the optical disc 100 which has: the protective layer 112a formed of alloy including SnSb₅; the coloring layer 111a formed of the cyanine organic dye shown in FIG. 3(b); the protective layer 112b formed of alloy including Zn; the coloring layer 111b formed of the cyanine organic dye shown in FIG. 3(a); the protective layer 112c formed of alloy including Sb; and the coloring layer 111c formed of, for example, an organic dye which presents green and whose melting point is about 300 degree Celsius, located in order from the irradiation side of the laser light LB.

As shown in FIG. 4(a), it is assumed that a partial area of the label layer 110 is irradiated with the laser light LB with a first laser power. Due to the irradiation of the laser light LB with the first laser power, the temperature of the partial area of the label layer 110 increases to about 300 degree Celsius or more, and less than 400 degree Celsius. In other words, the laser light LB with the first laser power corresponding to a laser power which can increase the temperature of the partial area of the label layer 110 to about 300 degree Celsius or more, and less than 400 degree Celsius is irradiated.

By this, the protective layer 112a with a melting point of about 232 to 240 degree Celsius melts, whereas the protective layer 112b with a melting point of 419.58 degree Celsius and the protective layer 112c with a melting point of about 630.7 degree Celsius do not melt. Therefore, the coloring layer 111a is visually recognized by a user in the partial area which is irradiated with the laser light LB, and it is visually recognized as a red-purple area. On the other hand, the protective layer 112a is visually recognized by a user in the other area which is not irradiated with the laser light LB, and it is visually recognized as a white area.

At this time, if the laser light LB is irradiated such that the partial area which is irradiated with the laser light LB with the first laser power has a shape of “P” in alphabet on the label layer 110, a user visually recognizes the label layer 110 in which the red-purple P is drawn, as shown in FIG. 4(b).

Then, as shown in FIG. 5(a), it is assumed that another partial area of the label layer 110 is irradiated with the laser light LB with a second laser power. Due to the irradiation of the laser light LB with the second laser power, the temperature of the another partial area of the label layer 110 increases to about 420 degree Celsius or more, and less than 600 degree Celsius. In other words, the laser light LB with the second laser power corresponding to a laser power which can increase the temperature of the another partial area of the label layer 110 to about 420 degree Celsius or more, and less than 600 degree Celsius is irradiated.

By this, both the protective layer 112a with a melting point of about 232 to 240 degree Celsius and the protective layer 112b with a melting point of 419.58 degree Celsius melt, whereas the protective layer 112c with a melting point of about 630.7 degree Celsius does not melt. In addition, the coloring layers 111a and 111b (further, 111c) also melt, each having a melting point of about 300 degree Celsius. Therefore, the coloring layers 111a and 111b are mixed in the another partial area which is irradiated with the laser light LB with the second laser power. Namely, in the another partial area which is irradiated with the laser light LB with the second laser power, it is visually recognized by a user as an area which presents black or nearly dark gray, obtained by mixing the coloring layers 111a and 111b.

At this time, if the laser light LB is irradiated such that the partial area which is irradiated with the laser light LB with the second laser power has a round shape surrounding the already drawn red-purple P on the label layer 110, a user visually recognizes the label layer 110 in which the red-purple P and the black or nearly dark gray circle surrounding it are drawn, as shown in FIG. 5(b).

Next, as shown in FIG. 6(a), it is assumed that another partial area of the label layer 110 is irradiated with the laser light LB with a third laser power. Due to the irradiation of the laser light LB with the third laser power, the temperature of the another partial area of the label layer 110 increases to about 640 degree Celsius or more. In other words, the laser light LB with the third laser power corresponding to a laser power which can increase the temperature of the another partial area of the label layer 110 to about 640 degree Celsius or more is irradiated.

By this, the protective layer 112a with a melting point of about 232 to 240 degree Celsius, the protective layer 112b with a melting point of 419.58 degree Celsius, and the protective layer 112c with a melting point of about 630.7 degree Celsius melt. In addition, the coloring layers 111a, 111b, and 111c also melt, each having a melting point of about 300 degree Celsius. Therefore, the coloring layers 111a, 111b, and 111c are mixed in the another partial area which is irradiated with the laser light LB with the third laser power. Namely, in the another partial area which is irradiated with the laser light LB with the third laser power, it is visually recognized by a user as an area which presents black, obtained by mixing the coloring layers 111a, 111b, and 111c.

At this time, if the laser light LB is irradiated such that the partial area which is irradiated with the laser light LB with the third laser power has a round shape with a predetermined radius concentric to the optical disc 100, on the label layer 110, a user visually recognizes the label layer 110 in which the red-purple P, the nearly black circle surrounding it, and the black circle concentric to the optical disc 100 are drawn, as shown in FIG. 6(b).

At this time, in addition to the irradiation of the laser light LB with the third laser power onto the another partial area of the label layer 110, the partial area of the label layer 110 which is already irradiated with the laser light with the first laser power may be irradiated with the laser light LB with the third laser power. By this, as shown in FIG. 7(a), in the partial area of the label layer 110 where only the protective layer 112a melts before the irradiation of the laser light LB with the third laser power, the protective layers 112b and 112c further melt, and the coloring layers 111a, 111b, and 111c are mixed.

As a result, as shown in FIG. 7(b), the alphabet “P” drawn in red-purple in the beginning is changed in color to black due to the irradiation of the laser light LB with the third laser light LB. As described above, by irradiating the laser light LB with a different laser power onto the area which is already irradiated with the laser light LB, it is possible to change the colors of the already drawn characters, numbers, graphics, and the like, or overwrite the already drawn characters, numbers, graphics, and the like.

As descried above, in accordance with the temperature given to a predetermined area of the label layer 110, at least two of the coloring layers 111a, 111b, and 111e can be mixed. Thus, by using the color presented by each of the coloring layers 111a, 111b, and 111c, or a plurality of colors presented by mixing at least two of the coloring layers 111a, 111b, and 111c, it is possible to draw the desired characters, numbers, graphics, and the like, onto the label layer 110. In particular, since the desired characters, numbers, graphics, and the like, can be drawn onto the label layer 110 by using the plurality of colors, the drawing (expression) has various aspects. For example, in the specific use aspects explained with reference to FIG. 4 to FIG. 6, the four colors in total, which are the color of the protective layer 112a, the color of the single coloring layer 111a, the color presented by mixing the coloring layers 111a and 111b, and the color presented by mixing the coloring layers 111a, 111b, and 111c, can be used to draw the desired characters, numbers, graphics, and the like. By this, two-color printing (or three-color printing) used in magazines and the like can be realized on the label layer 110. Therefore, it is possible to draw the characters, numbers, graphics, and the like which are bright or well visible for a user.

In particular, since the mixture of the plurality of coloring layers 111a, 111b, and 111c is adjusted by using the protective layers 112a, 112b, and 112c, there is the following excellent advantage, as compared to the above-mentioned patent document 1. Specifically, in the recording medium described in the above-mentioned patent document 1, there is a strict limitation on the distribution of energy given to develop colors in color elements used for the coloring layers (or the temperatures at which the color elements react with developers). Namely, in the patent document 1, the color-developing in the coloring layers is not enough, and the energy given to develop a color in each of the color elements used for the coloring layers (or the temperatures at which the color elements react developers) needs to be different from each other. In the present invention, however, if the melting points of the protective layers 112 satisfy the above-mentioned condition, it is only necessary that the coloring layers 111 present predetermined colors. Moreover, the protective layers 112 use the metal or alloy with relatively high melting points, so that most of the organic dyes used for the coloring layers 111 have lower melting points than those of the protective layers 112. Thus, if the protective layers 112 melt, at least two of the coloring layers 111 can be mixed. Therefore, the melting points of the coloring layers 111 do not greatly limit the range of selections of the materials used for the coloring layers 111. Namely, it is only necessary to select the coloring layers 111 which present the predetermined colors, so that the range of selections of the materials used for the coloring layers 111 can be widened more than in the patent document 1. Moreover, since the range of selections of the materials used for the coloring layers 111 can be widened, for example, such coloring layers 111 that can present more various types of colors can be constructed by using more various materials. Thus, it is possible to further emphasize a contrast of the characters, numbers, graphics, and the like to be drawn.

In addition, the protective layers 112 use the white-colored metal or alloy, so that it is possible to further emphasize a contrast of the colors presented by the coloring layers 111. In particular, the protective layer 112a, located on the nearest side as viewed from the irradiation side of the laser light LB, uses the white-colored metal or alloy, so that in a way, the characters, numbers, graphics, and the like are drawn with respect to the white-colored background, by using the colors presented by the coloring layers 111. Thus, it is possible to further emphasize a contrast between the background and the characters, numbers, graphics, and the like to be drawn. As a result, it is possible to draw the characters, numbers, graphics, and the like which are bright or well visible for a user.

The protective layers 112 are not necessarily the white-colored metal or alloy. However, in terms of the emphasis of the contrast, the white-colored metal or alloy is preferably used.

In addition, the film thickness of each of the coloring layers 111 is greater than that of each of the protective layers 112, so that the colors presented by the coloring layers 111 can be preferably visually recognized by a user regardless of the presence or the absence of the protective layers 112. Namely, it can be constructed such that it is relatively difficult for a user to visually recognize the colors presented by the protective layers 112, whereas it is relatively easy for the user to visually recognize the colors presented by the coloring layers 111. As a result, it is possible to draw the characters, numbers, graphics, and the like which are bright or well visible for a user, without influence of the protective layers 112.

Moreover, from the viewpoint that the plurality of coloring layers 111a, 111b, and 111c are separated from each other, the protective layer 112a, located on the nearest side as viewed from the irradiation side of the laser light LB, is not necessarily formed. However, from the viewpoint of further emphasizing a contrast between the background and the characters, numbers, graphics, and the like, the protective layer 112a is preferably formed. Moreover, if the protective layer 112a is formed, it is also possible to receive such a benefit that a user does not directly visually recognize the coloring layer 111a before the irradiation of the laser light LB.

Moreover, from the viewpoint that at least two of the plurality of coloring layers 111a, 111b, and 111c are mixed, each of the protective layers 112a, 112b, and 112c is not necessarily formed. In this case, the melting point of the coloring layer 111a needs to be lower than that of the coloring layer 111b, and the melting point of the coloring layer 111b needs to be lower than that of the coloring layer 111c. Namely, the coloring layer 111 located on the nearer side (or closer side) as viewed from the irradiation side of the laser light LB, needs to have lower melting point.

Moreover, since the protective layers 112 also melt and are mixed with the coloring layers 111, the protective layers 112 may be used to adjust (change) the colors presented by the coloring layers 111 to be mixed.

Moreover, the label layer 110 preferably has the structure, such as groove tracks, formed as in the recording layer 130. The structure like the groove tracks or the like, is used to control the irradiation position of the laser light LB when the desired characters, numbers, graphics, and the like are drawn onto the label layer 110. Namely, when the desired characters, numbers, graphics, and the like are drawn onto the label layer 110, the position to be irradiated with the laser light LB is recognized by using the structure like the groove tracks or the like, and the power of the laser light LB with which the position is to be irradiated is controlled. The relevant operation will be explained in detail later.

(Recording Apparatus)

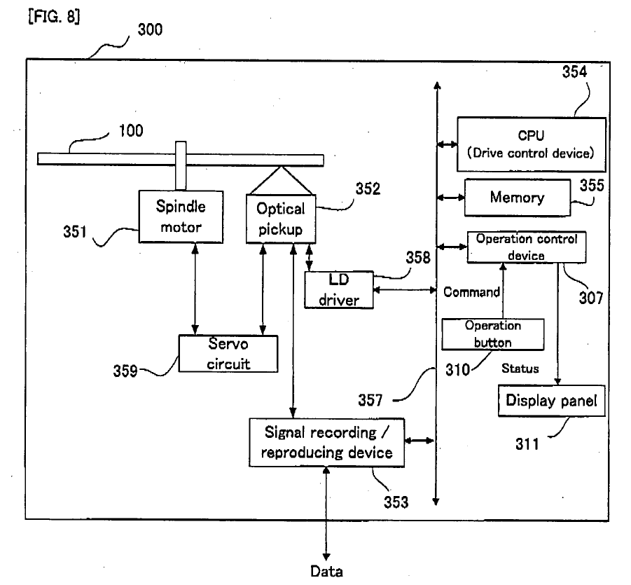

Next, with reference to FIG. 8, an embodiment of the recording apparatus of the present invention will be explained.

(1) Basic Structure

Firstly, with reference to FIG. 8, the basic structure of the recording apparatus in the embodiment will be explained. FIG. 8 is a block diagram conceptually showing a recording apparatus 300 in the embodiment.

As shown in FIG. 8, the recording apparatus 300 is provided with: the optical disc 100; a spindle motor 351; an optical pickup 352; a signal recording/reproducing device 353; a CPU (drive control device) 354; a memory 355; a Laser Diode (LD) driver 358; a servo circuit 359; a data input/output control device 306; an operation button 310, a display panel 311; and a bus 357.

The spindle motor 351 is intended to rotate and stop the optical disc 100, and operates upon accessing the optical disc 100. More specifically, the spindle motor 351 is constructed to rotate the optical disc 100 at a predetermined speed and stop it, under spindle servo from the servo circuit 359.

The optical pickup 352 constitutes one example of the “irradiating device” of the present invention. The optical pickup 352 is to record or reproduce the record data into or from the recording layer 130, or to record the characters, numbers, graphics, and the like into the label layer 110. The optical pickup 352 is provided with a semiconductor laser device, a lens, and the like. More specifically, the optical pickup 352 (or its lens) is constructed to be displaced, particularly in the radial direction of the optical disc 100, under tracking servo from the servo circuit 359.

The signal recording/reproducing device 353 constitutes one specific example of the “recording device” of the present invention. The signal recording/reproducing device 353 controls the optical pickup 352, to thereby perform the recording/reproduction with respect to the optical disc 100.

The memory 355 is used in the general data processing on the disc drive 300, including a buffer area for the record data, an area used as an intermediate buffer when data is converted into the data that can be used on the signal recording/reproducing device 353, and the like. Moreover, the memory 355 is provided with: a Read Only Memory (ROM) area into which a program for performing an operation as a recording device, namely, a firmware program is stored; and a Random Access Memory (RAM) area in which a buffer used for the compression/decompression of video data and a parameter required for a program operation are stored; and the like.

The CPU (drive control device) 354 is connected to the signal recording/reproducing device 353, the memory 355, the LD driver 358, and the servo circuit 359 via the bus 357, and controls the entire information recording/reproducing apparatus 300 by giving an instruction to each controlling device. In general, software for operating the CPU 354 is stored in the memory 355.

The data input/output control device 306 controls the input/output of the data from the exterior with respect to the information recording/reproducing apparatus 300, and performs storage into and export from the data buffer on the memory 355. If the input/output of the data is performed by using a video signal, upon the data inputting, the data received from the exterior is compressed (or encoded) into the MPEG format and outputted to the memory 355, and upon the data outputting, the data in the MPEG format received from the memory 355 is decompressed (or decoded) and outputted to the exterior.

An operation control device 307 receives an operation instruction and performs displaying, with respect to the information recording/reproducing apparatus 300. The operation control device 307 transmits the instruction given by using the operation button 310, such as instructions to record or reproduce, to the processor 354, and outputs the operational state of the information recording/reproducing apparatus 300, such as during recording and during reproduction, on the display panel, such as a fluorescent tube.

The LD driver 358 constitutes one specific example of the “power controlling device” of the present invention, and drives the semiconductor laser apparatus disposed in the optical pickup 352 under the control of the CPU 354. By this, the laser light LB with a predetermined laser power is irradiated from the optical pickup 352. More specifically, the semiconductor laser apparatus is driven to irradiate the laser light LB with the first laser power, as reading light, upon the data reproduction, and to irradiate the laser light LB with the second laser power, with it modulated, as writing light, upon the data recording. Moreover, the semiconductor laser is driven to irradiate the laser light LB with a predetermined laser power, depending on the coloring layers 111 to be mixed (i.e. the melting points of the protective layers 112 which separate the coloring layers 111 to be mixed), when the characters, numbers, graphics, and the like are recorded onto the label layer 110.

The servo circuit 359 constitutes one specific example of the “position controlling device” of the present invention. The servo circuit 359 drives the optical pickup 352 (or the lens thereof) on the basis of a LPP (land pre-pit) signal, and a wobble signal, focus error signal, or tracking error signal, which are obtained by processing the light receiving result of the optical pickup 352. By this, the servo circuit 359 performs various servo processes, such as tracking control and focus control. Alternatively, the servo circuit 359 controls the number of rotations of the spindle motor 351, to thereby perform various servo processes, such as spindle control.

One example of the information recording/reproducing apparatus 300 in household equipment is recorder equipment for recording and reproducing video images. The recorder equipment records, onto a disc, a video signal from a broadcast receiving tuner and an external connection tuner, and outputs the video signal reproduced from the disc to external display equipment, such as a television. The operation as the recorder equipment is performed by executing the program stored in the memory 355, on the CPU 354.

(3) Operation Principle

Next, an explanation will be given for an operation principle of drawing the characters, numbers, graphics, and the like desired by a user, into the label layer 110 on the optical disc 100 in the embodiment, by using the information recording/reproducing apparatus 300 in the embodiment.

Firstly, the desired characters, numbers, graphics, and the like which the user is about to draw in the label layer 110 are inputted, for example, by using the operation button 310 or the like. Moreover, at the same time, what color is used to draw the display targets, or what contrast is used to draw the display targets, or the like, is inputted.

Then, on the basis of the user's input result, the irradiation position of the laser light LB and the laser power of laser light LB at that time are determined. Then, in order to irradiate the determined irradiation position with the laser light LB, the position of the optical pickup 352 and the rotational speed of the optical disc 100 or the like are controlled by the operation of the servo circuit 359. Moreover, in order to irradiate the laser light LB with the determined laser power, the operation of the semiconductor laser for oscillating the laser light LB or the like is controlled by the operation of the LD driver 358. By this, as specifically explained in FIG. 4 to FIG. 7, the desired characters, numbers, graphics, and the like are drawn into the label layer 110.

On the other hand, when the record data is recorded into the recording layer 130, the laser light LB is irradiated onto the recording layer 130 from the opposite side to the side from which the laser light LB is irradiated onto the label layer 110. At this time, the recording layer 130 is irradiated with the laser light LB modulated in accordance with the record data to be recorded by the operation of the signal recording/reproducing device 353, whereby the record marks or the like are formed onto the recording surface of the recording layer 130. Moreover, when the record data recorded in the recording layer 130 is reproduced, a RF signal obtained by receiving the reflected light of the laser light LB is outputted to the signal recording/reproducing device 353. Then, various processes, such as demodulating and an error-correcting, are performed on the RF signal by the operation of the signal recording/reproducing device 358, and it is reproduced via external equipment, such as a display and a speaker.

Moreover, in the above-mentioned embodiments, the optical disc 100 is explained as one example of the recording medium, and the recorder related to the optical disc 100 is explained as one example of the recording apparatus. The present invention, however, is not limited to the optical disc and the recorder thereof, and can be applied to other various high-density-recording or high-transmission-rate information recording media, and the recorders thereof.

The present invention is not limited to the above-described embodiments, and various changes may be made, if desired, without departing from the essence or spirit of the invention which can be read from the claims and the entire specification. A recording medium, a recording apparatus and method, and a computer program for recording control, all of which involve such changes, are also intended to be within the technical scope of the present invention.

### INDUSTRIAL APPLICABILITY

The recording medium, the recording apparatus and method, and the computer program according to the present invention can be applied to a high-density optical disc, such as a DVD, and further to a recording apparatus, such as a DVD recorder. Moreover, they can be applied to a recording apparatus or the like which is mounted on various computer equipment for consumer use or for commercial use, or which can be connected to various computer equipment.

1. A recording medium comprising:
a substrate; and
a plurality of coloring layers which are laminated on the substrate, each of said coloring layers presenting a predetermined color, wherein at lest two adjacent coloring layers are mixed due to a change in temperature caused by irradiation of laser light in the plurality of coloring layers.

2. The recording medium according to claim 1, wherein a protective layer is provided between the plurality of coloring layers.

3. The recording medium according to claim 2, further comprising a protective layer on a side nearer than the coloring layer located on the nearest side as viewed from an irradiation side of the laser light.

4. The recording medium according to claim 2, wherein light absorptivity of the protective layer is less than that of each of the plurality of coloring layers.

5. The recording medium according to claim 2, wherein the protective layer located on the nearest side as viewed from the irradiation side of the laser light has the lowest melting point.

6. The recording medium according to claim 2, wherein a melting point of the protective layer is higher than that of the coloring layer adjacent the protective layer.

7. The recording medium according to claim 2, wherein a melting point of the protective layer is higher than that of each of the plurality of coloring layers.

8. The recording medium according to claim 2, wherein a thickness of each of the plurality of coloring layers is greater than that of the protective layer.

9. The recording medium according to claim 1, wherein one of the coloring layers located on the nearest side as viewed from an irradiation side of the laser light has the lowest melting point.

10. The recording medium according to claim 1, wherein the plurality of coloring layers has respective different light absorption peaks.

11. The recording medium according to claim 1, wherein the plurality of coloring layers includes respective a cyanine organic dye.

12. The recording medium according to claim 1, further comprising a recording layer in which predetermined record information can be recorded.

13. A recording apparatus comprising:
an irradiating process for irradiating a recording medium, said recording medium including a substrate and a plurality of coloring layers laminated on the substrate, each of said coloring layers presenting a predetermined color and at least two adjacent coloring layers being mixed due to a change in temperature caused by irradiation of laser light in the plurality of coloring layers with the laser light;
a power-controlling device for controlling power of the laser light; and
a position-controlling device for controlling a position which is irradiated with the laser light.

14. The recording apparatus according to claim 13, wherein the recording medium further comprises a recording layer in which predetermined record information can be recorded, and said recording apparatus further comprises a recording device for recording the record information.

15. A recording method comprising:
an irradiating device for irradiating a recording medium, said recording medium including a substrate and a plurality of coloring layers laminated on the substrate, each of said coloring layers presenting a predetermined color and at least two adjacent coloring layers being mixed due to a change in temperature caused by irradiation of laser light in the plurality of coloring layers with the laser light;
a power-controlling process for controlling power of the laser light; and
a position-controlling process for controlling a position which is irradiated with the laser light.

16. A computer program product in a computer-readable medium for tangibly embodying a program of instructions executable by a computer provided in a recording apparatus to make the computer function as at least one of an irradiating device, a power-controlling device, and a position-controlling device, said recording apparatus comprising:
said irradiating device for irradiating a recording medium, said recording medium including a substrate and a plurality of coloring layers laminated on the substrate, each of said coloring layers presenting a predetermined color and at least two adjacent coloring layers being mixed due to a change in temperature caused by irradiation of laser light in the plurality of coloring layers with the laser light;
said power-controlling process for controlling power of the laser light; and
said position-controlling process for controlling a position which is irradiated with the laser light.
